(19) United States
(12) Patent Application Publication
(10) Pub. No.: US 2010/0088797 A1
(43) Pub. Date: Apr. 15, 2010

(54) CAMOUFLAGE PATTERN APPLIED TO A SURFACE

(75) Inventors: Jason Simione, Stuart, FL (US); John Simione, Hollywood, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Bulldog Equipment, LLC, Hollywood, FL (US)

(21) Appl. No.: 12/249,171

(22) Filed: Oct. 10, 2008

(51) Int. Cl. A41D 1/00; B32B 3/10; B05D 5/06

(52) U.S. Cl. 2/69; 428/195.1; 427/267

(57) ABSTRACT

A disruptive camouflage pattern is disclosed that includes a base color and a plurality of shapes. Each shape includes a color selected from a plurality of colors. At least a first shape is overlaid onto the base color and multiple shapes selected from the plurality of shapes are overlaid onto the base color and/or the first shape thereafter. At least a portion of a set of the multiple shapes is overlaid on to each other. Each of the multiple shapes is at least one of rotated, inverted, and/or resized with respect to another shape in the camouflage pattern so as to avoid a repeated pattern within a given area of the camouflage pattern. Each of the plurality of shapes includes hard edges so as to create a minutely pixilated pattern.

### FIELD OF THE INVENTION

The present invention generally relates to the field of uniform apparel, and more particularly relates to a garment top and bottom for use in military, law enforcement, and security environments.

### BACKGROUND OF THE INVENTION

Camouflage patterns are used to conceal the individual wearing garments with the pattern and/or items including the pattern. However, many current camouflage patterns are not applicable to a wide variety of environments. For example, many camouflage patterns are designed specifically for an urban, forest, or desert environment. These patterns include colors that are specific to the environment. Therefore, different patterns and colors are used based on the environment. This causes the clothing and an item comprising a pattern to be changed each time a new environment is encountered. Another problem with current camouflage patterns is that some patterns repeat patterns. Repeating patterns are generally less effective in concealing an individual or item because the human eye tries to recognize patterns. Therefore, camouflage patterns with repeated patterns are less effective for concealment.

Therefore a need exists to overcome the problems with the prior art as discussed above.

### SUMMARY OF THE INVENTION

In one embodiment a disruptive camouflage pattern is disclosed. The disruptive camouflage pattern includes a base color and a plurality of shapes. Each shape includes a color selected from a plurality of colors. At least a first shape is overlaid onto the base color and multiple shapes selected from the plurality of shapes are overlaid onto the base color and/or the first shape thereafter. At least a portion of a set of the multiple shapes is overlaid on to each other. Each of the multiple shapes is at least one of rotated, inverted, and/or resized with respect to another shape in the camouflage pattern so as to avoid a repeated pattern within a given area of the camouflage pattern. Each of the plurality of shapes includes hard edges so as to create a minutely pixilated pattern.

In another embodiment, a garment is disclosed. The garment includes a front side and a backside. The garment also includes a disruptive camouflage pattern that is printed on at least a portion of at least one of the front side and the backside. The disruptive camouflage pattern includes a base color and a plurality of shapes. Each shape comprises a color selected from a plurality of colors. At least a first shape being overlaid onto the base color and multiple shapes selected from the plurality of shapes being overlaid onto the base color and/or the first shape thereafter. At least a portion of a set of the multiple shapes is overlaid on to each other. Each of the multiple shapes having been at least one of rotated, inverted, and/or resized with respect to another shape in the camouflage pattern so as to avoid a repeated pattern within a given area of the camouflage pattern. Each of the plurality of shapes includes hard edges so as to create a minutely pixilated pattern.

In yet another embodiment, a method for creating a disruptive camouflage pattern on a surface is disclosed. The method includes applying a base color to a surface. Each following steps is performed until at least four different colors are printed. A shape is selected from a plurality of shapes. A color is selected from a plurality of colors to be associated with the shape. The shape is printed, for a first time, on the surface with the color that has been selected at a first orientation comprising at least a first angle of rotation. The shape is printed, for at least a second time, on the surface at a second orientation comprising at least a second angle of rotation printing, for at least a second time. At least a portion of the shape printed for at least the second time partially overlaps at least a portion of the shape printed the first time.

One advantage of the various embodiments of the present invention is that a camouflage pattern is presented that provides a non-repeating pixilated pattern. Colors and shapes are used to address both the configuration of the target to be hidden and the nature of the background into which the target must blend. The colors that are included within the camouflage pattern are found in most environments, thereby, making the camouflage pattern applicable to almost any environment. Another advantage of the various embodiments is that the camouflage pattern provides disruption of the target shape, a matching of the spatial characteristics of the environment, and background matching.

### BRIEF DESCRIPTION OF THE DRAWINGS

In compliance with 37 C.F.R §1.84(a)(2) the standards for color drawings, this patent or application file contains at least one drawing executed in color. Copies of this patent or patent application publication with color drawing(s) will be provided by the U.S. Patent and Trademark Office upon request and payment of the necessary fee.

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a top view of a camouflage pattern according to one embodiment of the present invention;

FIG. 2 is a top-side perspective of a first camouflage pattern shape and a second camouflage pattern shape that is to be overlaid on top of first camouflage pattern shape according to one embodiment of the present invention;

FIG. 3 is a top view of the second camouflage pattern shape overlaid on top of the first camouflage pattern shape according to one embodiment of the present invention;

FIG. 4 is a top view of a plurality of camouflage pattern shapes according to one embodiment of the present invention; and

FIG. 5 is an operational flow diagram illustrating one process for creating the camouflage pattern of FIG. 1 according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Camouflage Pattern

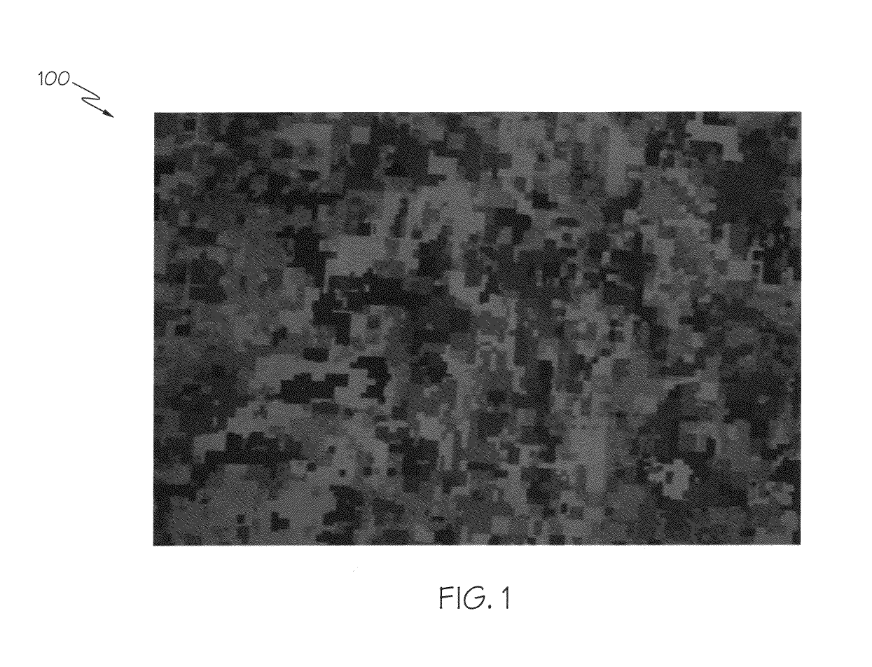

FIG. 1 shows a plain view of a camouflage pattern 100 according to one embodiment of the present invention. In particular, FIG. 1 shows a new and advantageous camouflage pattern 100 that is applicable to a variety of environments encountered by military (and civilian) personnel. For example, the camouflage pattern 100 of FIG. 1 is applicable to a woodland, urban, mountainous, tropical, and desert environment to name a few.

In one embodiment, the camouflage pattern 100 includes 10 mono-chromatic colors. However, it should be noted that one or more colors can be added and/or deleted. The color scheme comprises variations of the following colors: dark grey 30, dark brown 68, silver 89, chestnut 86, bright green 49, olive 107, coyote 124, taupe 140, clay 160, and gold 175. These colors and their variations were created for Bulldog Equipment, LLC by Duro Textiles, LLC of Fall River, Mass. ([www.duroindustries.com]). These colors were selected because most environments include all or at least a majority of these colors. Therefore, by using all or a combination of these colors in the camouflage pattern 100, the camouflage pattern 100 becomes applicable to virtually any environment.

The Gestalt approach to perception emphasizes that we perceive objects as well-organized patterns rather than separate component parts. According to this approach, when we open our eyes we do not see fractional particles in disorder. Instead, we notice larger areas with defined shapes and patterns. The “whole” that we see is something that is more structured and cohesive than a group of separate particles.

Therefore, the camouflage pattern 100, in one embodiment, provides a non-repeating pixilated pattern that uses colors and shapes to address both the configuration of the target to be hidden and the nature of the background into which the target must blend. In other words, the camouflage pattern 100 provides disruption of the target shape, a matching of the spatial characteristics of the environment, and background matching. The pixel pattern of one embodiment of the present invention provides improved disruption of a subject over existing patterns.

In one embodiment, a various number of shapes are used within the camouflage pattern. One or more base colors such as (but not limited to) tan can be used with a plurality of shapes each comprising a color being laid on top of the base color. In one embodiment, each of the shapes is overlaid in high wearing minutely pixilated patterns. The same pixels are used for each color and when a new color is applied the pixels are changed by flipping, inverting, and/or rotating the shapes in different positions. In the camouflage pattern 100 of FIG. 1, each color has its own shape, different sizing, and location, thereby, eliminating any area of similarity in the pattern. Stated differently, a noticeable pattern of shapes, sizes, positions, and/or colors cannot be perceived in the camouflage pattern 100 for any given area of the surface on which the pattern 100 is printed on.

This is advantageous because each time a perceiver's eye focuses on a shape it tries to recognize the shape from past memory. The eye begins to move to other areas expecting the same shape and color to remain constant. Therefore, by constantly changing shapes and colors as in the camouflage pattern 100 of FIG. 1, the eye cannot focus or recognize what it is seeing. The camouflage pattern 100 confuses the eye because the eye is unable to locate any patterns or shapes that it has previously seen within the camouflage pattern 100.

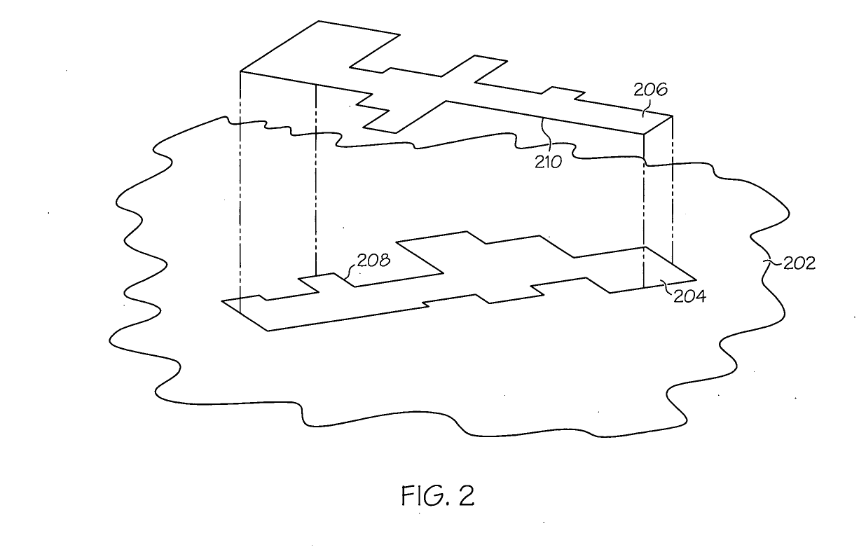

FIG. 2 shows one embodiment of overlaying a shape to create the camouflage pattern 100 of FIG. 1. In particular, FIG. 2 shows a base color 202, a first shape 204, and a second shape 206. Only two shapes 204, 206 have been shown for simplicity. In the embodiment of FIG. 2, the first shape 204 has been overlaid onto the base color 202 at a first location and in a first position. The second shape 206, in one embodiment, comprises a different color than the first shape 204 and is of a different shape than the first shape 204. However, it should be noted that two similar shapes with or without similar coloring can be overlaid on top of each other was well. In another embodiment, two shapes may be similar with respect to their outline but can have different dimensions. For example, if the first shape 204 and the second shape 206 had a similar outline (i.e., similar shape) one of the shapes can be smaller than the other shape.

As can be seen in FIG. 2, each of the shapes 204, 206 comprise straight edges 208, 220 that are perpendicular to other edges. In other words, the edges 208, 220 of each shape are not curved and create a 90 degree angle with an intersecting edge. It should be noted that other embodiments, utilize shapes with intersecting edges having angles less than or greater than 90 degrees. These edges in combination with the various colors of the shapes create the pixilated pattern 100 of FIG. 1 when a shape 206 is overlaid onto another shape 204.

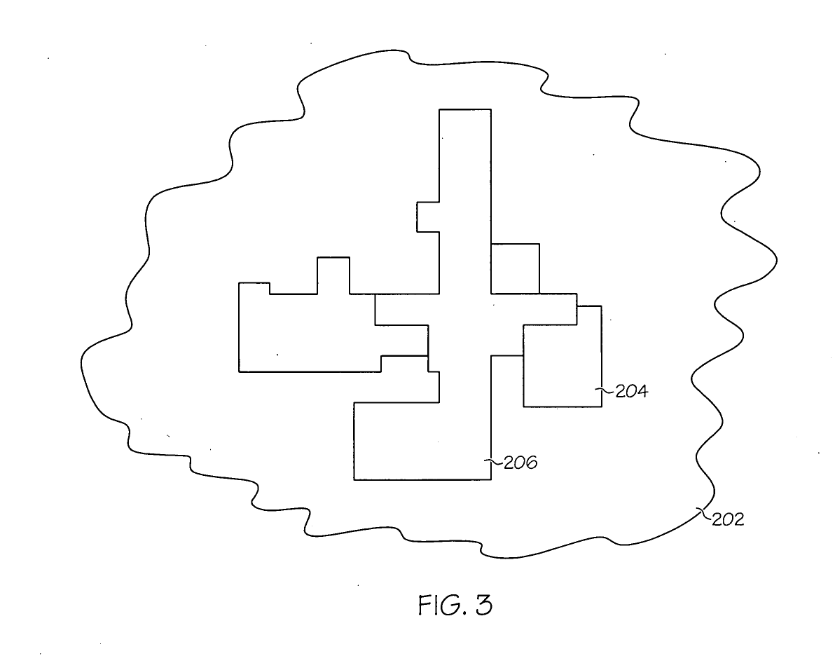

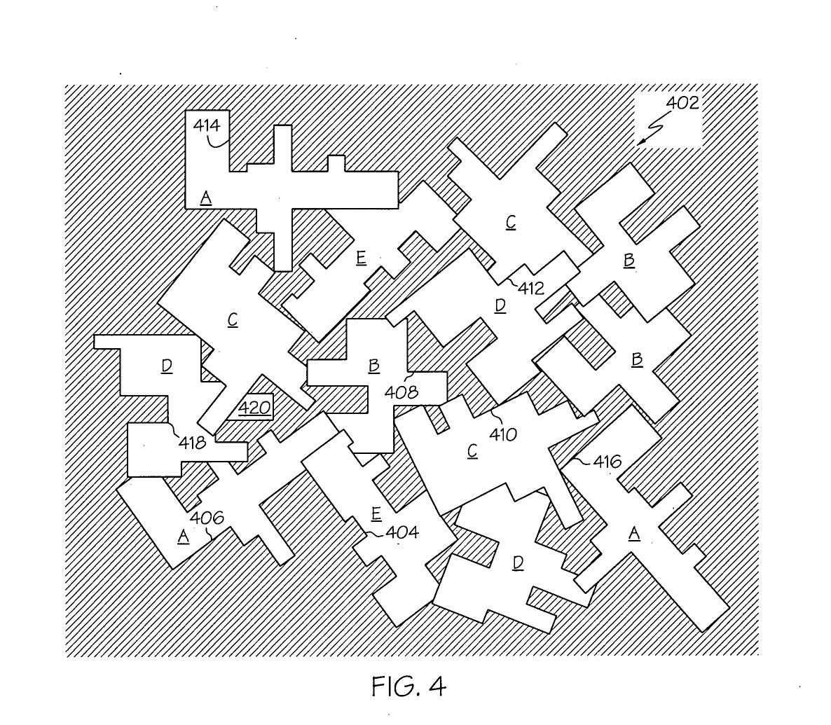

For example, FIG. 3 shows the second shape 206 overlaid on top of the first shape 204. As more and more shapes are added to pattern 100 and overlaid on top of one another, the pattern 100 becomes more pixilated as shown in FIG. 4 (and FIG. 1). Also, as one shape 206 is laid on top of another shape 204, the shape on the bottom is changed, thereby, creating a new shape.

FIG. 4 shows a plurality of shapes 304, 306, 308, 310, 312 and a base color 302. In particular, FIG. 4 shows 5 different shapes 304, 306, 308, 310, 312 labeled “A”, “B”, “C”, “D”, and “E”. It should be noted that additional shapes can be removed and/or added and the present invention is not limited to 5 different shapes. It should also be noted that spacing between the shapes 304, 306, 308, 310, 312 has been purposely exaggerated for illustration purposes only.

Although the area of the camouflage pattern 100 shown in FIG. 4 includes repeated shapes such as shape “A” 306, a perceivable repeated pattern is not created. This is because a repeated shape within the camouflage pattern 100 can have a different color, size, location, and orientation with respect to other similar shapes. For example, a first shape “A” 306 has been rotated differently than a second shape “A” 314 and a third shape “A” 316. Each of these shapes 306, 314, 316 are also overlaid on other shapes and/or have shapes laid on top of them. This changes the shapes 306, 314, 316 even further. Furthermore, each of these shapes can have any of the 10 colors discussed above.

For example, the first shape “A” 306 has a shape “D” 318 and a shape “E” 304 overlaid on top of it. This creates a new shape “A” that is different from the other shape “As”. Therefore, by rotating, resizing, changing colors, and repositioning the shapes 304, 306, 308, 310, 312, perceivable repeated patterns are avoided. The exposed portions of each shape 304, 306, 308, 310, 312 such as portion 320 create the pixilated pattern shown in FIG. 1. This ability to create a pixilated pattern without repeatable patterns provides improved disruption of the subject and background blending.

It should be noted that the camouflage pattern 100 of FIG. 1 is applicable to a variety of items such as fabrics, metals, composites, plastics, and the like. For example, the camouflage pattern 100 can be printed on uniforms, vehicles, weapons or any other item/material capable of accepting print, paint, dye, and/or graphics.

In one embodiment, at least a portion of the pattern is applied to a uniform. One example of a uniform that has been shown to be used advantageously with the present invention is described in co-pending patent application entitled “COMBAT UNIFORM” with inventor Jason Simione, U.S. patent application Ser. No. ______, now [pending] and assigned herewith to Bulldog Equipment, LLC of Hollywood, Fla. which is hereby incorporated by reference in its entirety. A variation of this pattern is shown in the design application U.S. Patent Application Number 29/303,336, now [pending] and assigned herewith to Bulldog Equipment, LLC of Hollywood Fla. which is hereby incorporated by reference in its entirety.

The camouflage pattern 100 can be “printed” onto a surface such as a fabric using acid dyes and overprinted vat dyes. For example, a base color such as tan can be applied to the fabric. Then each of the dark grey, dark brown, bright green, silver, chestnut, olive, coyote, taupe, clay colors can be applied to the fabric on top of the tab base color using a different screen for each of the colors. The result is the pattern 100 shown in FIG. 1. It should be noted that printing processes other than a screen printing process can be used to create the camouflage pattern 100.

Overall Process for Creating the Camouflage Pattern of FIG. 1

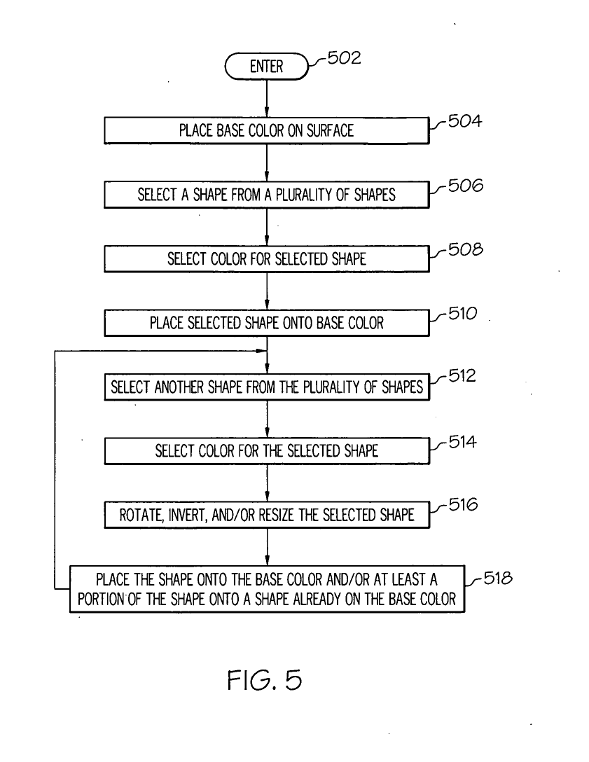

FIG. 5 is an operational flow diagram illustrating one process for creating the camouflage pattern 100 of FIG. 1. The operational flow diagram of FIG. 5 begins at step 502 and flows directly to step 504. A base color such as (but not limited to) gold, at step 504, is printed onto a surface of a given such size such as (but not limited to 36 inches). A shape 204, at step 506, is selected from a plurality of shapes. A color such as (but not limited to) dark grey, dark brown, bright green, silver, chestnut, olive, coyote, taupe, and clay, at step 508, is selected for the shape 204.

The shape 204 with the selected color, at step 510, is overlaid on top of the base color and printed onto the surface using any printing technique such as (but not limited to) screen printing. Another shape 206, at step 512, is selected from the plurality of shapes. A color such as (but not limited to) dark grey, dark brown, bright green, silver, chestnut, olive, coyote, taupe, clay, and tan, at step 514, is selected for the newly selected shape 206. The newly selected shape 206, at step 516, is at least one of rotated, inverted, and/or resized.

The newly selected shape 206, at step 516, is then overlaid onto the base color and/or at least a portion of the selected shape 206 is overlaid onto a shape (shape as shape 204) already printed on the base color. The process of selecting a new shape (or an already used shape), selecting a color for the shape, and rotating the shape is repeated until a given number of shapes have been printed onto the surface. The control flow then returns to step 512 where the above process is repeated until the camouflage pattern 100 is completed.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A disruptive camouflage pattern comprising:
a base color; and
a plurality of shapes,
wherein each shape comprises a color selected from a plurality of colors, at least a first shape being overlaid onto the base color and multiple shapes selected from the plurality of shapes being overlaid onto the base color and/or the first shape thereafter, wherein at least a portion of a set of the multiple shapes are overlaid on to each other, and wherein each of the multiple shapes having been at least one of rotated, inverted, and/or resized with respect to another shape in the camouflage pattern so as to avoid a repeated pattern within a given area of the camouflage pattern, wherein each of the plurality of shapes includes hard edges so as to create a minutely pixilated pattern.

2. The disruptive camouflage pattern of claim 1, wherein the base color is tan.

3. The disruptive camouflage pattern of claim 1, wherein the plurality of colors comprises at least a variation of:
dark grey,
dark brown,
bright green,
silver,
chestnut,
olive,
coyote,
taupe,
clay, and
gold.

4. The disruptive camouflage pattern of claim 1, wherein the multiple shapes includes at least two substantially similar shapes.

5. The disruptive camouflage pattern of claim 4, wherein the two substantially similar shapes are rotated, inverted, and/or resized with respect to one another in the disruptive camouflage pattern.

6. The disruptive camouflage pattern of claim 1, wherein the multiple shapes includes at least two substantially similar colored shapes.

7. A garment including:
a front side;
a backside; and
a disruptive camouflage pattern printed on at least a portion of at least one of the front side and the backside, wherein the disruptive camouflage pattern includes:
a base color; and
a plurality of shapes,
wherein each shape comprises a color selected from a plurality of colors, at least a first shape being overlaid onto the base color and multiple shapes selected from the plurality of shapes being overlaid onto the base color and/or the first shape thereafter, wherein at least a portion of a set of the multiple shapes are overlaid on to each other, and wherein each of the multiple shapes having been at least one of rotated, inverted, and/or resized with respect to another shape in the camouflage pattern so as to avoid a repeated pattern within a given area of the camouflage pattern, wherein each of the plurality of shapes includes hard edges so as to create a minutely pixilated pattern.

8. The garment of claim 7, wherein the base color is tan.

9. The garment of claim 1, wherein the plurality of colors comprises at least a variation of:
dark grey,
dark brown,
bright green,
silver,
chestnut,
olive,
coyote,
taupe,
clay, and
gold.

10. The garment of claim 7, wherein the multiple shapes includes at least two substantially similar shapes.

11. The garment of claim 10, wherein the two substantially similar shapes are rotated, inverted, and/or resized with respect to one another in the disruptive camouflage pattern.

12. The disruptive camouflage pattern of claim 7, wherein the multiple shapes includes at least two substantially similar colored shapes.

13. A method for creating a disruptive camouflage pattern on a surface, the method comprising:
applying a base color to a surface;
wherein each following steps is performed until at least four different colors are printed:
selecting a shape from a plurality of shapes:
selecting a color from a plurality of colors to be associated with the shape:
printing, for a first time, the shape on the surface with the color that has been selected at a first orientation comprising at least a first angle of rotation; and
printing, for at least a second time, the shape on the surface at a second orientation comprising at least a second angle of rotation, wherein at least a portion of the shape printed for at least a second time partially overlaps at least a portion of the shape printed the first time.

14. The method of claim 13, wherein printing shape for at least a second time, further comprises at least one of:
rotating the at least second shape;
inverting the at least second shape; and
resizing the at least second shape.

15. The method of claim 13, wherein shape printed for at least a second time is printed onto the surface at a 90 degree angle with respect to the shape printed for a first time.

16. The method of claim 13, wherein each of the plurality of shapes includes hard edges so as to create a minutely pixilated pattern when printed onto the surface.

17. The method of claim 13, wherein the base color is tan.

18. The method of claim 13, wherein the color is selected from a group of colors comprising:
dark grey,
dark brown,
bright green,
silver,
chestnut,
olive,
coyote,
taupe,
clay, and
gold.

19. The method of claim 13, wherein the plurality of shapes includes at least two substantially similar shapes.

20. The method of claim 13, wherein the shape is printed using at least one of:
a VAT dye; and
an Acid dye.
